(19) United States
(12) Patent Application Publication
(10) Pub. No.: US 2011/0070053 A1
(43) Pub. Date: Mar. 24, 2011

(54) UNIVERSAL SAFETY END CAP

(76) Inventor: Chin-Chuan Chang,, Taipei City (TW)

(21) Appl. No.: 12/562,132

(22) Filed: Sep. 18, 2009

(51) Int. Cl. F16B 37/14

(52) U.S. Cl. 411/429

(57) ABSTRACT

A universal safety end cap includes a body, provided therein with a receiving portion. The receiving portion has a plurality of segments of different diameters and lengths. The segments are such arranged that the segment having the least diameter is closest to a close end of the receiving portion while the segment having the greatest diameter is farthest from the close end and open to an open end of the receiving portion, so that the receiving portion is capable of fittingly receiving sharp ends of different specifications therein. The universal safety end cap, when removably mounted around a sharp end of a steel bar, a steel rod, an iron component, an aluminum component, a preformed stick-shaped material, a mechanical device, furniture, or a public facility, helps to protect relevant workers or the public from accidents and secure their priceless life. The end cap can also incorporate esthetic design for decoration.

### BACKGROUND OF THE INVENTION

1. Technical Field

The present invention relates safety end caps for preformed stick-shaped materials, and more particularly, to a universal safety end cap adaptive to preformed stick-shaped materials with sharp ends such as steel bars, steel rods, iron components, and aluminum components of various specifications, so as to cover such sharp ends and prevent the same from injuring people.

2. Description of Related Art

At construction sites there are usually steel bars, steel rods, iron components, aluminum components and other preformed stick-shaped materials of various specifications with sharp ends that may hurt workers if no protective measure is taken. One such protective conventional approach is to wrap the sharp ends with wooden pieces. However, as such wooden pieces are often makeshifts and not fit to the ends, they can easily come off or displace from where they are arranged under impact or during transportation of the stick-shaped materials, thus being unreliable.

Another known approach is to mount plastic pipe segments or traditional cap covers to those sharp ends of stick-shaped materials. Both the plastic pipe segments and the traditional end caps provide their function due to an axial hole thereof allowing a sharp end of a stick-shaped material to be received therein with relatively fitting combination. However, in practical use at construction sites, it is inconvenient and economical for workers to prepare the plastic pipe segments or traditional end caps in several different sizes that match stick-shaped materials of various specifications. Consequently, stick-shaped materials with different diameters and heights may be paired with unfitting end caps, resulting excessively loose or excessively tight combination. While such excessively loose combination leads to coming off of the plastic pipe segments or traditional cap covers, the excessively tight combination can cause the plastic pipe segments and the traditional end caps to deform and fail to function after repeated use. Hence, all the existing protective measurements for this purpose seem not satisfying when reliability and economical benefits are taken into consideration.

In view of the shortcomings of the prior art approaches, such as being inconvenient, unreliable, unstable and uneconomical, a universal safety end cap that meets people's needs in a more convenient, reliable, stable and economical way is therefore desired.

### SUMMARY OF THE INVENTION

The primary objective of the present invention is to provide a universal safety end cap, wherein the universal safety end cap is configured to removably fit a sharp end of a steel bar, a steel rod, an iron component, an aluminum component, a preformed stick-shaped material, a mechanical device, a piece of furniture, or a public facility of any specification so as to protect relevant workers or the public from accidents and secure their priceless life.

The universal safety end cap of the present invention includes a body that is formed therein with a receiving portion. The receiving portion comprises a plurality of segments that have different diameters and lengths. The segments are such arranged that the segment having the least diameter is closest to a close end of the receiving portion while the segment having the greatest diameter is farthest from the close end and open to an open end of the receiving portion. The receiving portion thus can be removably fixed to sharp ends of materials or devices of different dimensions.

In the universal safety end cap of present invention, the body may have an integrally formed flanged head at a close end thereof that may be configured to present various shapes and patterns for decoration. The body may further have an integrally formed hollow column where the receiving portion is provided. The hollow column shall have a simple structure that is adaptive to mass molding production. The hollow column may be provided with decorations at an outer periphery thereof and may be made with an increased thickness for enhancing its strength, thus improving the safety and stability in use. The plural segments of different diameters and lengths may be each formed with a smooth inner periphery or a threaded or engraved inner periphery for better safety and stability in use.

The present invention thus has the following features.

The subject matter of the present invention is suitable to sharp ends of steel bars, steel rods, iron components, aluminum components, preformed stick-shaped materials, mechanical devices, furniture, or public facilities of various specifications so as to protect relevant workers or the public from accidents and secure their priceless life.

The receiving portion of the present invention can fit sharp ends of steel bars, steel rods, iron components, aluminum components and other preformed stick-shaped materials of various specifications, and is also applicable to sharp ends of mechanical devices, furniture, or public facilities of various specifications. The receiving portion is endurable and unlikely to deform after repeated use. In addition, the present invention may incorporate esthetic design to give a decorative function.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawing, wherein:

FIG. 1 is a perspective view of a universal safety end cap of the present invention;

FIG. 2 is a lateral view of the universal safety end cap of the present invention;

FIG. 3 is a sectional view of the universal safety end cap of the present invention;

FIG. 4 is a first applied view of the universal safety end cap of the present invention; and

FIG. 5 is a second applied view of the universal safety end cap of the present invention.

### DETAILED DESCRIPTION OF THE PREFERRED EMBODIMENT

While a preferred embodiment provided hereinafter for illustrating the concept of the present invention as described above, it is to be understood that the components of the embodiment shown in the accompanying drawings are depicted for the sake of easy explanation and need not to be made in scale.

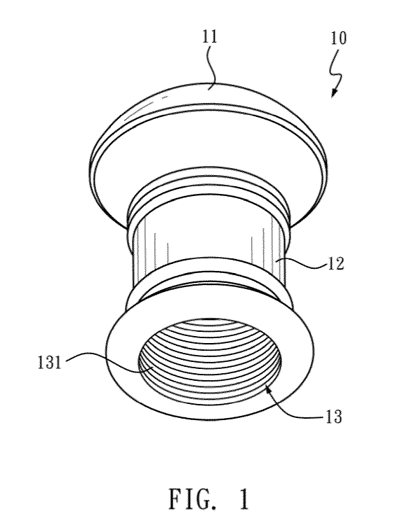

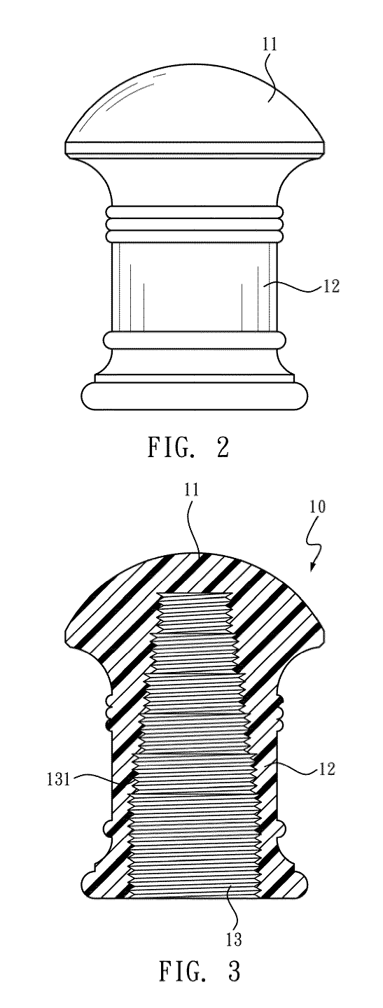

Referring to FIGS. 1 through 3, a universal safety end cap according to the present invention primarily includes a body 10 that is composed of a flanged head 11 and a hollow column 12. The flanged head 11 has a vaulted end surface, and the hollow column 12 is provided therein with a receiving portion 13. The receiving portion 13 comprises several coaxial, successive segments 131 with different diameters and lengths, wherein the segment 131 having the least diameter is closest to the head 11 while the segment 131 having the greatest diameter is farthest from the head 11 and open to an open end of the receiving portion 13.

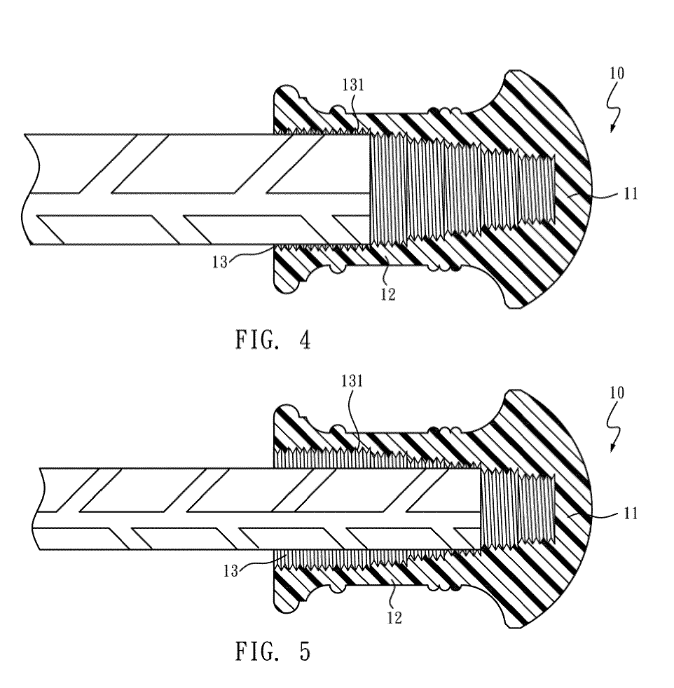

As can be seen from FIGS. 4 and 5, in virtue of the receiving portion 13, the universal safety end cap can easily fit ends of steel bars, steel rods, iron components, aluminum components and other preformed stick-shaped materials of various specifications. The universal safety end cap can also accommodate ends of mechanical devices, furniture, or public facilities of various specifications. Since the receiving portion 13 is formed from the plural segments 131 of the different diameters and lengths, when a sharp end to be capped is inserted into the receiving portion 13, it can be received by a said segment 131 that fits it best. The flanged head 11 has an end surface that is roughly vaulted, so as to protect the relevant works and the public. The plural segments 131 of the receiving portion 13 may be each formed with a smooth inner periphery. Alternatively, they may each have a threaded or engraved inner periphery so that when the body 10 is combined with the sharp end to be capped, the combination therebetween is firmer and unlikely to loose.

The body 10 composed of the vaulted-surfaced flanged head 11 and the hollow column 12 has a relatively simple structure and is adaptive to mass molding production. Moreover, the hollow column 12 may be provided with decorations at an outer periphery thereof and may be made with an increase thickness so that when impacted or rammed, the disclosed end cap is unlikely to break, thus enhancing the reliability and stability of the end cap in use.

In addition, the flanged head 11 and the hollow column 12 may be made to have various shapes, dimensions, and forms, and may be further provided with esthetic features, such as patterns, figures, symbols, and literal characters, so that when used in house for furnishing, such end cap can directly give a decorative appearance, adding our living environment with enhanced esthetics.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A universal safety end cap, comprising a body that is provided therein with a receiving portion, the receiving portion including a plurality of segments of different diameters and lengths, and the segments being such arranged that the segment having the least diameter is closest to a close end of the receiving portion while the segment having the greatest diameter is farthest from the close end and open to an open end of the receiving portion, so that the receiving portion is capable of fittingly receiving an end of an external stick-shaped object.

2. A universal safety end cap of claim 1, wherein the receiving portion has a smooth periphery.

3. The universal safety end cap of claim 1, wherein the receiving portion has a threaded or engraved periphery.

4. The universal safety end cap of claim 1, wherein the body comprises a flanged head and a hollow column that are integratedly formed, the flanged head having a vaulted end surface and being provided with patterns, figures, symbols, or literal characters.

5. The universal safety end cap of claim 4, wherein the hollow column has a smooth outer periphery.

6. The universal safety end cap of claim 4, wherein the hollow column has an outer periphery provided with decoration so as to have an increased thickness.

7. The universal safety end cap of claim 4, wherein the hollow column has an outer periphery provided with decorative patterns for esthetics.
